(19) United States
(12) Patent Application Publication
(10) Pub. No.: US 2023/0273961 A1
(43) Pub. Date: Aug. 31, 2023

(54) INFORMATION PROCESSING DEVICE AND INFORMATION PROCESSING METHOD

(71) Applicant: Sony Group Corporation, Tokyo (JP)

(72) Inventor: Ryosuke MITANI, Tokyo (JP)

(73) Assignee: Sony Group Corporation, Tokyo (JP)

(21) Appl. No.: 18/005,857

(22) PCT Filed: Aug. 19, 2021
(86) PCT No.: PCT/JP2021/030290

§ 371 Date: Jan. 18, 2023

(30) Foreign Application Priority Data
Sep. 1, 2020 (JP) 2020-147159

(51) Int. Cl. G06F 16/9032

(52) U.S. Cl. CPC G06F 16/90332

(57) ABSTRACT

An information processing device (100) according to an embodiment of the present disclosure includes: a reception unit (154) that receives answer information related to a first answer that corresponds to a question query indicating a question about first content and that is generated on the basis of the first content; and a generation unit (153) that generates a second answer corresponding to the question query on the basis of second content different from the first content in a case where the answer information does not satisfy a predetermined condition.

### FIELD

The present disclosure relates to an information processing device and an information processing method.

### BACKGROUND

In an answer learning device that is an example of an information processing device, a technology of determining, on the basis of an input sentence and a question sentence, polarity of an answer to the question sentence by using a previously-learned determination model to determine whether the polarity of the answer to the question sentence in the sentence is positive is provided (for example, Patent Literature 1). According to this technology, a question that can be answered in polarity can be answered in polarity with high accuracy.

### CITATION LIST

### Patent Literature

Patent Literature 1: Japanese Patent Application Laid-open No. 2020-61173

### SUMMARY

### Technical Problem

However, in the related art, although a question query such as a question sentence can be answered in polarity, a case where there is no answer is not considered. For example, in a case where no answer can be found in a certain document, when detection of the case itself is possible, it is possible to increase a score of a benchmark widely performed as research. In these cases, increasing the benchmark score occupies a major part of an object and disadvantages of a user of a case where no answer can be found is not considered. Thus, it is difficult to reliably acquire an answer to a question query for which no answer can be found, and a correct answer probability (=number of correct answers/number of problems) decreases.

Thus, the present disclosure proposes an information processing device and an information processing method capable of increasing a correct answer probability of an answer to a question query.

### Solution to Problem

An information processing device according to the embodiment of the present disclosure includes: a reception unit that receives answer information related to a first answer that corresponds to a question query indicating a question about first content and that is generated on a basis of the first content; and a generation unit that generates a second answer corresponding to the question query on a basis of second content different from the first content in a case where the answer information does not satisfy a predetermined condition.

### BRIEF DESCRIPTION OF DRAWINGS

FIG. 1 is a view illustrating an example of information processing according to an embodiment of the present disclosure.

FIG. 2 is a view illustrating a configuration example of an information processing device according to the embodiment of the present disclosure.

FIG. 3 is a view illustrating an outline of the information processing according to the embodiment of the present disclosure.

FIG. 4 is a flowchart illustrating a procedure of the information processing according to the embodiment of the present disclosure.

FIG. 5 is a view illustrating a first example of a retrieval user interface (UI) image according to the embodiment of the present disclosure.

FIG. 6 is a view illustrating a second example of a retrieval UI image according to the embodiment of the present disclosure.

FIG. 7 is a view illustrating a first example of an answer UI image according to the embodiment of the present disclosure.

FIG. 8 is a view illustrating a second example of an answer UI image according to the embodiment of the present disclosure.

FIG. 9 is a view illustrating an example of a selection UI image according to the embodiment of the present disclosure.

FIG. 10 is a view illustrating a configuration example of an information processing system according to another embodiment of the present disclosure.

FIG. 11 is a view illustrating a configuration example of hardware according to another embodiment of the present disclosure.

### DESCRIPTION OF EMBODIMENTS

In the following, embodiments of the present disclosure will be described in detail on the basis of the drawings. Note that these embodiments do not limit an information processing device and an information processing method according to the present disclosure. Also, in each of the following embodiments, overlapped description is omitted by assignment of the same reference sign to the same parts.

Each of one or a plurality of embodiments (including example and modification example) described in the following can be performed independently. On the other hand, at least a part of the plurality of embodiments described in the following may be appropriately combined with at least a part of the other embodiments. The plurality of embodiments may include novel features different from each other. Thus, the plurality of embodiments can contribute to solving different objects or problems, and can exhibit different effects.

The present disclosure will be described in the following order of items.
1. Introduction
2. Embodiment
2-1. Configuration of an information processing device according to the embodiment
2-2. Outline of information processing according to the embodiment
2-3. Procedure of the information processing according to the embodiment
2-4. UI image example according to the embodiment
2-5. Effects according to the embodiment
3. Other embodiments
3-1. Modification example
3-2. Other modification examples
3-3. Hardware configuration
4. Appendix

### 1. Introduction

In general, in technical development for reading, in a case where no answer is included in a document that is an example of content (also referred to as medium), when it is possible to detect the case itself, it is possible to increase a benchmark score. Thus, behavior of a case where no answer can be found in content of a retrieval object is not sufficiently considered. On the other hand, when a reading service is actually provided to a user, a state in which no answer can be returned to a question query (query) of the user is a problem, and becomes one of causes of a decrease in a service utilization rate and reduction of users.

Thus, in the embodiment of the present disclosure, in a case where no answer to a question query of a user can be found in answer retrieval on content (first content) (for example, case where there is no answer, case where the question query is difficult to understand, or the like), in order to avoid a situation in which the answer to the user cannot be returned, answer retrieval on another content (second content) is performed, whereby an answer to the question query is reliably acquired and it is realized to increase a correct answer probability.

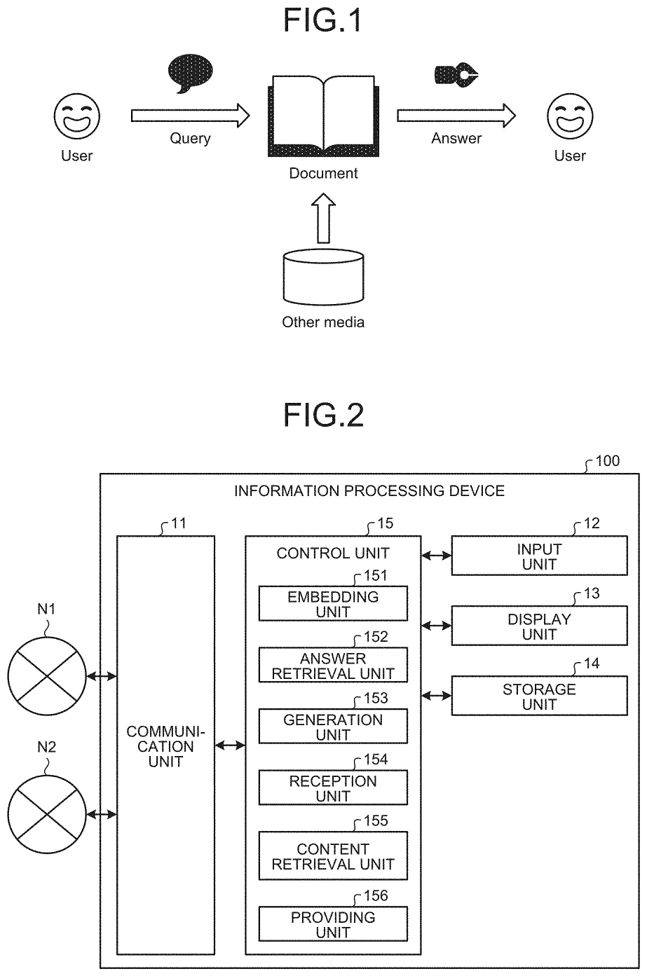

For example, as illustrated in FIG. 1, when a user (User) inputs a question query (Query) to a document (Document) that is an example of content, an answer to the question query is retrieved from the document. In a case where no answer to the question query can be found from the document, the answer to the question query is retrieved from other content (other media). The answer (Answer) acquired by this retrieval is provided to the user. The other content is new content to be a next answer retrieval object (hereinafter, referred to as new content).

Such content reading processing is realized by, for example, a content reading application (medium reading application) that executes processing by a computer. When the question query and the content (such as document) are provided to the content reading application, an answer to the question query is retrieved from the content, and an answer is retrieved from another content in a case where no answer can be acquired. The content reading application is an application that provides, to computer-readable content, a question query described in natural language related to contents thereof and points to an answer to the question query.

### 2. Embodiment

<2-1. Configuration of an Information Processing Device According to the Embodiment>

A configuration of an information processing device according to the embodiment will be described. FIG. 2 is a view illustrating a configuration example of the information processing device according to the embodiment of the present disclosure.

An information processing device 100 illustrated in FIG. 2 is a device that executes content reading processing as information processing according to the embodiment. This information processing device 100 is a terminal device used by a user. As the information processing device 100, for example, various devices used by the user, such as a smartphone, a tablet terminal, a notebook personal computer (PC), a desktop PC, a mobile phone, and a personal digital assistant (PDA) are used.

Note that the information processing device 100 is not limited to the terminal device used by the user, and may be any device. For example, an information processing device that performs the content reading processing and a terminal device used by the user may be separate bodies (see modification example described later). In a case where the information processing device and the terminal device are separate bodies, the information processing device functions as a server, for example.

Furthermore, although Japanese will be described as an example in the embodiment, the information processing executed by the information processing device 100 is not limited to Japanese, and may be performed in various languages such as English, French, and German. For example, the content reading processing may target content in a language related to the question query or a language corresponding to a translation language of the language. That is, the information processing device 100 may perform processing on any language as long as the content reading processing can be executed.

As illustrated in FIG. 2, the information processing device 100 includes a communication unit 11, an input unit 12, a display unit 13, a storage unit 14, and a control unit 15. In the example of FIG. 2, the information processing device 100 includes the input unit 12 (such as keyboard or mouse) that receives various kinds of operation from the user or the like, and the display unit 13 (such as liquid crystal display) to display various kinds of information.

The communication unit 11 is realized, for example, by a network interface card (NIC), a communication circuit, or the like. The communication unit 11 is connected to a first communication network N1 and a second communication network N2 in a wired or wireless manner, and transmits and receives information to and from other devices and the like via the first communication network N1 and the second communication network N2.

As the first communication network N1, for example, a local network (LAN), an in-house network, or the like is used. The second communication network N2 is a communication network having lower confidentiality than the first communication network N1. As the second communication network N2, for example, a wide area network (WAN), the Internet, an external network, or the like is used. However, for example, in a case where the WAN is used as the first communication network N1, the Internet is used as the second communication network N2.

The input unit 12 receives various kinds of operation such as input operation from the user. This input unit 12 is, for example, a keyboard, a mouse, a touch panel, or the like provided in the information processing device 100, and receives the input operation from the user. Furthermore, the input unit 12 may receive the input operation by a voice of the user. Examples of the input operation include input operation such as an input of a question query and content by the user.

The display unit 13 displays various kinds of information. For example, the display unit 13 is a display device such as a liquid crystal display or an organic electro luminescence (EL) display, and displays various kinds of information such as an answer generated by the content reading processing.

Note that the information processing device 100 may include not only the display unit 13 but also a function (configuration) of outputting information, such as a function of outputting the information as sound. As an example, the information processing device 100 may include a sound output unit such as a speaker that outputs sound.

The storage unit 14 is realized by a semiconductor memory element such as a random access memory (RAN) or a flash memory, or a storage device such as a hard disk or an optical disk, for example. This storage unit 14 stores, for example, various kinds of information such as information necessary for the content reading processing and an answer generated by the content reading processing.

The control unit 15 includes, for example, a computer such as a central processing unit (CPU) or a micro processing unit (MPU). This control unit 15 functions as a controller. For example, the control unit 15 may be realized by a computer executing a program (such as information processing program) stored in the information processing device 100 with a RAM or the like as a work area. Also, the control unit 15 may be realized by, for example, an integrated circuit such as an application specific integrated circuit (ASIC) or a field programmable gate array (FPGA).

This control unit 15 includes an embedding unit 151, an answer retrieval unit 152, a generation unit 153, a reception unit 154, a content retrieval unit 155, and a providing unit 156. Each of these units 151 to 156 is realized by, for example, one or both of hardware and software. The control unit 15 realizes or executes a function and an action of information processing described below. Note that an internal configuration of the control unit 15 is not limited to the configuration illustrated in FIG. 2, and may be another configuration as long as being a configuration of performing the information processing described later. When necessary, the control unit 15 acquires a learning model (such as content reading model) from the storage unit 14 or an external device that provides the learning model, and uses the learning model. The information processing described below is appropriately realized on the basis of various learning models.

The embedding unit 151 converts text included in the question query into embedded expression (numerical vector). For example, the embedding unit 151 converts the question query into a question query vector having a fixed length. As the processing of converting the text into the embedded expression, natural language processing (learning model) that converts the text into vector expression is used, and Bidirectional Encoder Representations from Transformers (BERT), Word2Vec, or the like is used, for example.

The answer retrieval unit 152 searches the content for a portion corresponding to an answer to the question query. For example, the answer retrieval unit 152 retrieves answer candidate blocks from the content. In the retrieval of the answer candidate blocks, the answer retrieval unit 152 divides the content input to the information processing device 100 in block units of a certain degree (degree to which an expected answer is included, such as sentence, clause, or paragraph), and performs conversion, for each block, into vector expression corresponding to the block, that is, a block vector. Furthermore, the answer retrieval unit 152 solves relevance degrees of the block vectors to the question query vector as a ranking problem, and searches for an answer candidate block having the highest rank.

For example, in a case where the content of the retrieval object is text, the text is divided into paragraphs or large clauses. Furthermore, for example, the content of the retrieval object is divided into scenes when being a moving image, is divided into melodies when being music, and is divided into audio sections when being an audio file. Each block (each section) is expressed as a feature vector on the basis of text such as subtitles, lyrics, and transcription included in the content.

The generation unit 153 specifies a portion suitable as an answer to the question query, that is, an answer (answer candidate) from the answer candidate block. For example, the generation unit 153 specifies a section indicating an answer portion when the portion corresponding to the answer candidate block is text, and specifies a time section indicating an answer portion when the portion corresponding to the answer candidate block is a moving image or a waveform corresponding to the text of the retrieval object. Then, the generation unit 153 edits the specified answer in an appropriate form as a response to the user, and generates an answer to be presented to the user. Furthermore, the generation unit 153 calculates a certainty factor of the answer. In a case where there is a plurality of answers, the certainty factor for each of the answers is calculated.

The reception unit 154 receives answer information related to the answer generated by the generation unit 153. In a case where the answer information satisfies a predetermined condition, this reception unit 154 instructs the providing unit 156 to output the answer information. On the other hand, in a case where the answer information does not satisfy the predetermined condition, the reception unit 154 instructs the content retrieval unit 155 to retrieve new content in order to perform the content reading processing on the new content (other content). In addition, the reception unit 154 instructs the content retrieval unit 155 to retrieve new content according to input operation on the input unit 12 by the user.

For example, in a case where the answer information is information indicating that no answer can be acquired, the reception unit 154 instructs the content retrieval unit 155 to retrieve new content since the answer information does not satisfy a predetermined condition that the answer information includes an answer. In addition, in a case where the answer information is information indicating an answer and a certainty factor of the answer and the certainty factor of the answer is smaller than a predetermined threshold, since a predetermined condition that the certainty factor of the answer included in the answer information is equal to or larger than the predetermined threshold is not satisfied, an instruction to retrieve new content is issued to the content retrieval unit 155.

The content retrieval unit 155 retrieves new content from various databases (DB) via the second communication network N2 according to the instruction from the reception unit 154. This content retrieval unit 155 uses the question query vector and retrieves new content related to the question query. For example, the content retrieval unit 155 solves relevance degrees of pieces of content with respect to the question query vector as a ranking problem from a database having various kinds of information, and retrieves new content having the highest rank. At this time, the content retrieval unit 155 may reflect a tendency of old content, which is the first answer retrieval object, on the ranking by simultaneously using not only the question query vector but also a vector of the content input by the user (content vector).

The providing unit 156 outputs (provides) answer information related to the answer generated by the generation unit 153 to the display unit 13 according to an output instruction (provision instruction) from the reception unit 154. The answer information may include not only the answer but also the certainty factor of the answer. In this case, the certainty factor is also displayed by the display unit 13 together with the answer. As a result, the user can grasp the certainty factor together with the answer. Furthermore, the providing unit 156 outputs a user interface image (UI image) related to the content reading processing to the display unit 13. Examples of the UI image include a UI image for retrieval, a UI image for an answer, a UI image for an input of content to be a new retrieval object, and the like. Each of these UI images will be described later.

<2-2. Outline of Information Processing According to the Embodiment>

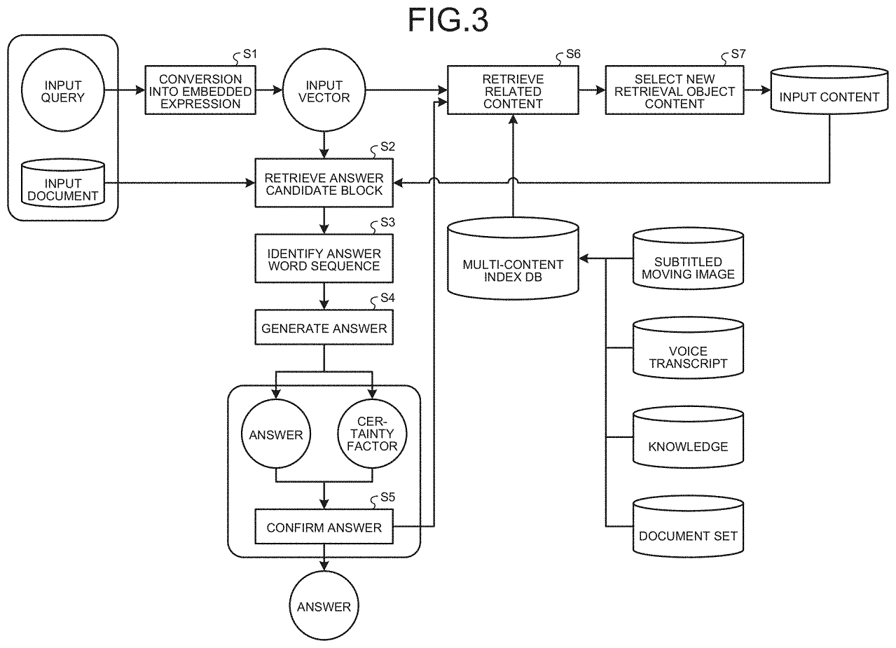

Next, the outline of the information processing according to the embodiment will be described with reference to FIG. 3. FIG. 3 is a view illustrating the outline of the information processing according to the embodiment. Specifically, FIG. 3 is a view illustrating an outline of the content reading processing as the information processing according to the embodiment. In the example of FIG. 3, a document (input document) is illustrated as an example of input content.

As illustrated in FIG. 3, an input query (input question query) is converted into an embedded expression (numerical vector) and is set as an input vector (question query vector) (Step S1). At this time, the input query is converted into an input vector having a fixed length by the embedding unit 151.

Then, an answer candidate block (such as answer candidate paragraph) is retrieved from the input document (input document) on the basis of the input vector (Step S2). At this time, the input document is divided in block units (such as paragraph units) by the answer retrieval unit 152, and a block vector (such as paragraph vector) is generated for each block. Relevance degrees of the block vectors to the input vector are solved as a ranking problem, and an answer candidate block having the highest rank is selected from among the blocks.

Note that the question query and the document are input to the information processing device 100 by the input operation on the input unit 12 by the user. Examples of the question query include “What is the height of Mount Fuji?”, “Who is the director of this film?”, “What is the name of the main character?”, and “Who is the leading actor?”. Furthermore, examples of the document include a web page, a paper, an internal document, and the like. In addition to the text such as this document, for example, voice (speech waveform), video, knowledge, or the like may be used as input content (input content). The content is information that can be processed by a computer.

Then, an answer word sequence is identified (Step S3). In the identification of the answer words sequence, a portion suitable as an answer to the question query, that is, an answer (answer candidate) is specified by the generation unit 153 for the target answer candidate block.

Then, an answer is generated (Step S4). In the generation of the answer, the specified answer is edited by the generation unit 153 into an appropriate form as a response to the user, and an answer to be presented to the user is generated. At this time, a certainty factor of the answer is also calculated.

Then, the answer is confirmed (Step S5). In the confirmation of the answer, the reception unit 154 determines whether the certainty factor of the answer is smaller than a threshold, and the answer is fed back to the user by the providing unit 156 in a case where the certainty factor of the answer is not smaller than the threshold. Specifically, the providing unit 156 transmits answer information including the answer to the display unit 13, and the display unit 13 displays the answer on the basis of the answer information. On the other hand, in a case where the certainty factor of the answer is smaller than the threshold, a state that the answer is not acquired is fed back to the user by the providing unit 156, and re-retrieval is performed. Furthermore, in a case where the user is not satisfied with the fed back answer, an instruction to perform the re-retrieval from the user is input by the input operation on the input unit 12 by the user, and the re-retrieval is performed.

Then, when the re-retrieval is performed, retrieval of related content is first performed (Step S6). In the retrieval from the related content, the content retrieval unit 155 retrieves a predetermined number (such as ten or more, several tens, or the like) of new content candidates (new input content candidate) related to the question query from various databases based on a multi-content index DB by using the question query vector described above. At this time, by simultaneous utilization of not only the question query vector but also the vector of the input document, a tendency of the old document that is the first answer retrieval object may be reflected on a result of the retrieval.

Here, the multimedia index DB is a database that records retrieval indexes of various kinds of content (media). In the example of FIG. 3, a subtitled moving image, a voice transcript, knowledge, and a document set are illustrated as various databases corresponding to each retrieval index. In addition to such content, examples of the content include a document (such as web page, book, minutes, internal document, or the like), a moving image with/without subtitles, voice with/without a transcript, a song with/without lyrics, and an image with/without a description. Vectors respectively representing the pieces of content are assigned to these pieces of content and the pieces of content are stored in the databases.

In a method of the vector assignment, a function in the following manner is used. That is, when a question query is given after a vector for each file is acquired by utilization of a method that converts a plurality of sentences into vector expression and that is represented by Doc2vec or the like, a relevance degree to a vector of a corresponding file becomes high. Note that for content (medium) to which no text is attached, a learning model in the following manner is used. That is, with data to which text is previously assigned being teacher data, the learning model learns a neural network that associates the text from the content, and can generate the text from the content.

Then, new content (new retrieval object content) is selected from new content candidates (Step S7). In the selection of the new content, each entry attachment is performed as a ranking problem for the question query vector from the predetermined number of new content candidates retrieved from the various databases based on the multi-content index DB, and the new content is determined by the content retrieval unit 155 on the basis of the result. For example, the content having the highest rank is determined as the new content.

Then, the processing returns to Step S2, and the processing on the new content is executed as in Step S2 to S5. That is, after the new content is selected, the processing returns to the retrieval of an answer candidate block for the new content (Step S2).

According to the outline of the information processing described above, an answer to the content given by the user can be retrieved in a natural sentence. Furthermore, for a question query (problem) that cannot be answered by the content given by the user, it is possible to acquire an answer to the question query by referring to other content, whereby it is possible to reliably acquire the answer to the question query. Furthermore, in a case where no answer can be found (such as case where there is no answer, or the like), it becomes possible to perform retrieval from information sources previously accumulated in the databases and it is possible to omit labor of the user to present new content, whereby it is possible to improve convenience of the user. Furthermore, by asking the user whether the answer is satisfactory (whether the answer is good) or whether to retrieve other new content, it is possible to give the user a choice. Thus, it is possible to improve the convenience of the user.

<2-3. Procedure of the Information Processing According to the Embodiment>

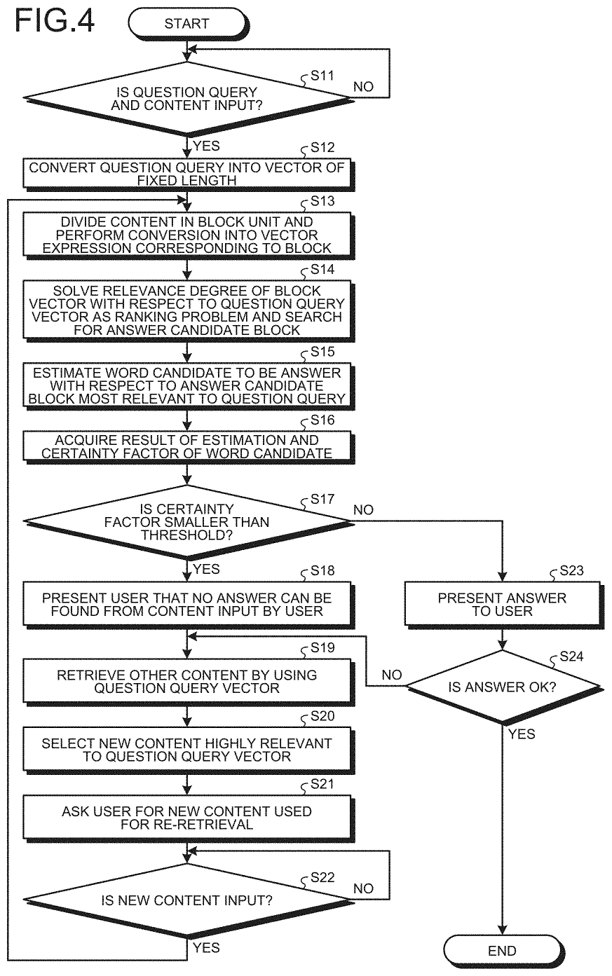

Next, the procedure of the information processing according to the embodiment will be described with reference to FIG. 4. FIG. 4 is a flowchart illustrating the procedure of the information processing according to the embodiment of the present disclosure.

As illustrated in FIG. 4, the control unit 15 of the information processing device 100 determines whether a question query and content are input (Step S11), and waits for an input thereof (NO in Step S11). When the question query and the content are input (YES in Step S11), the control unit 15 converts the question query into a vector in a fixed length (Step S12).

The control unit 15 divides the content in block units, and performs conversion into vector expressions corresponding to the blocks (Step S13). In a case where the content is a document such as an article, the document is divided, for example, in paragraph units and converted into vector expressions corresponding to the paragraphs. The control unit 15 solves relevance degrees of the block vectors to the question query vector as a ranking problem, and searches for a target answer candidate block (Step S14).

The control unit 15 estimates a word candidate (answer candidate) to be an answer from the answer candidate block having the highest rank, that is, the most relevant to the question query (Step S15). The control unit 15 acquires a result of the estimation and a certainty factor of the word candidate (Step S16). In a case where there is one word candidate, the control unit 15 sets the one word candidate as an answer. In a case where there is a plurality of word candidates, the control unit 15 acquires a certainty factor of each word candidate and sets a word candidate having the highest certainty factor as an answer.

The control unit 15 determines whether the certainty factor of the answer is smaller than a threshold (Step S17). When determining that the certainty factor of the answer is smaller than the threshold (YES in Step S17), the control unit 15 presents to the user that no answer can be acquired from the content input by the user (Step S18). Specifically, the control unit 15 transmits answer information indicating that no answer is acquired to the display unit 13. On the basis of the received answer information, the display unit 13 displays words, images, and the like indicating that no answer is acquired.

The control unit 15 retrieves other content (new content) by using the question query vector (Step S19). For example, the control unit 15 retrieves other content from a database prepared in advance. The control unit 15 selects new content highly relevant to the question query vector (Step S20). The relevance degrees of the content with respect to the question query vector is solved as a ranking problem, and new content is searched for.

The control unit 15 asks the user about the new content to be used for the re-retrieval (Step S21). For example, for the re-retrieval, the user is asked whether to input new content or to input the new content acquired in Step S20 described above. As an example, a UI image enabling such selection is transmitted from the providing unit 156 to the display unit 13 and displayed by the display unit 13. The user operates the input unit 12, and directly inputs new content or inputs the new content by issuing an instruction to input the new content acquired in Step S20 described above.

The control unit 15 determines whether the new content is input (Step S22), and waits for an input of the new content (NO in Step S22). When determining that the new content is input (YES in Step S22), the control unit 15 returns the processing to Step S13. In and after Step S13, processing similar to what is described above is executed on the new content.

On the other hand, when determining that the certainty factor of the answer is not smaller than the threshold (NO in Step S17), the control unit 15 presents the answer to the user (Step S23). Specifically, the control unit 15 transmits answer information including an answer, a certainty factor, and the like to the display unit 13, and the display unit 13 displays the answer on the basis of the answer information. At this time, the display unit 13 may display the certainty factor of the answer together with the answer.

The control unit 15 determines whether the answer is OK (Step S24). For example, the user operates the input unit 12 and inputs whether the answer is OK (for example, satisfactory). When determining that the answer is not OK (NO in Step S24), the control unit 15 advances the processing to Step S19. In and after Step S19, processing similar to what is described above is executed. On the other hand, when determining that the answer is OK (YES in Step S24), the control unit 15 ends the processing.

In the above-described information processing procedure, according to the certainty factor of the answer acquired from the content input by the user, for example, in a case where the certainty factor is smaller than the predetermined threshold, new content related to the question query is retrieved from the predetermined database, and an answer retrieval for the new content is executed. As a result, in a case where an answer acquired from the content input by the user is inaccurate, the answer retrieval for the new content is executed and an accurate answer to the question query can be reliably acquired. In addition, since the answer retrieval for new content is executed until the user is satisfied with the answer, it is possible to increase a probability that the answer satisfying the user can be acquired.

<2-4. UI Image Example According to the Embodiment>

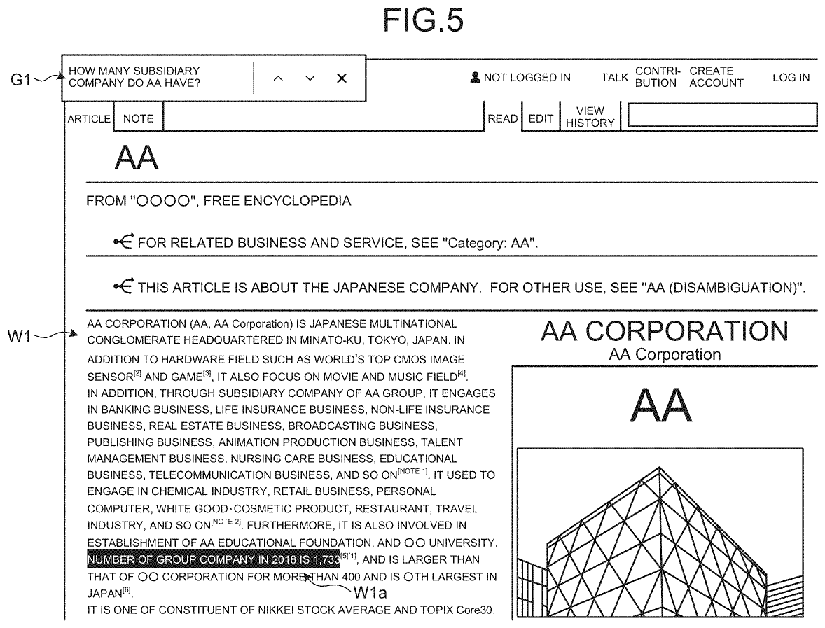

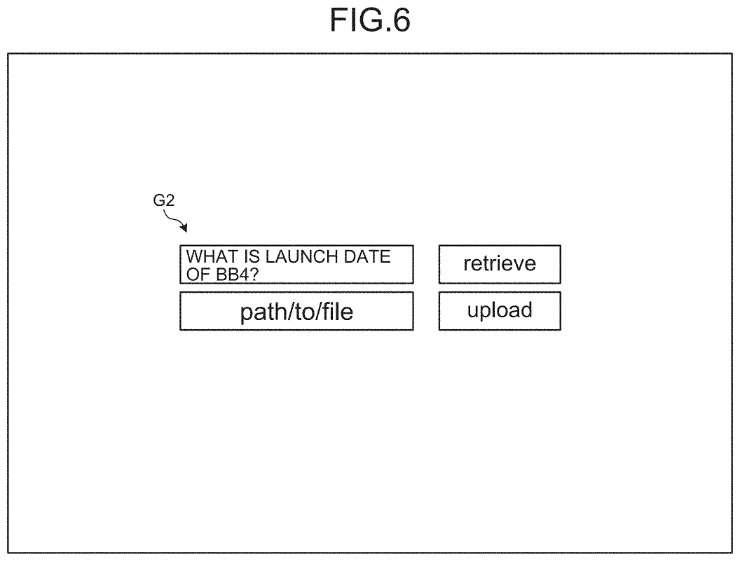

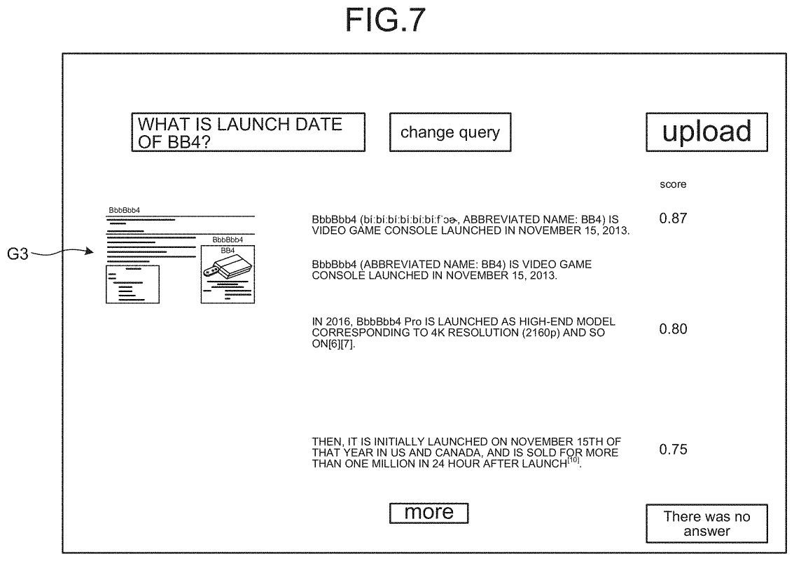

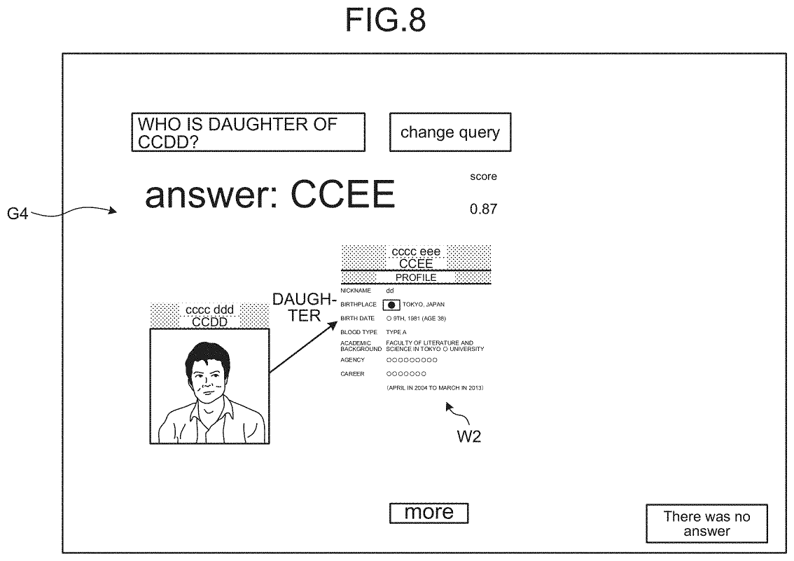

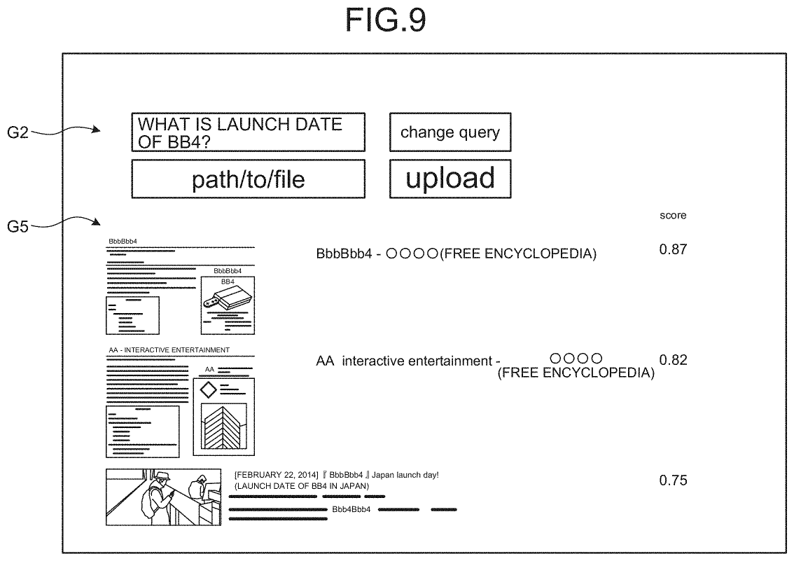

Next, UI image examples (first to fifth examples) according to the embodiment will be described with reference to FIG. 5 to FIG. 9. FIG. 5 is a view illustrating a first example of a retrieval UI image according to the embodiment. FIG. 6 is a view illustrating a second example of a retrieval UI image according to the embodiment. FIG. 7 is a view illustrating a first example of an answer UI image according to the embodiment. FIG. 8 is a view illustrating a second example of an answer UI image according to the embodiment. FIG. 9 is a view illustrating an example of a selection UI image according to the embodiment.

In the first example, as illustrated in FIG. 5, a retrieval UI image G1 to input a question query is displayed. In the example of FIG. 5, a uniform resource locator (URL) or the like of a web page is designated by input operation on the input unit 12 by the user, and a web page document (such as dictionary, article, or the like) W1 is displayed. A question query is input to a question input field (question input area) of the retrieval UI image G1 according to the input operation on the input unit 12 by the user. In the example of FIG. 5, a sentence “How many subsidiary companies does AA have?” is input. When this question query is input, the above-described content reading processing is executed and an answer W1a is indicated. In the example of FIG. 5, a marker is drawn at a portion of the answer W1a in the web page document W1, and the answer W1a is emphasized.

In the second example, as illustrated in FIG. 6, a retrieval UI image G2 to input a question query and content is displayed. A question query is input to a question input field of the retrieval UI image G2 according to the input operation on the input unit 12 by the user. In the example of FIG. 6, a sentence “What is the launch date of BB4?” is input. Furthermore, in a content input field of the retrieval UI image G2, a path or a file (path/to/file) is designated by the input operation on the input unit 12 by the user. Then, an upload button (upload) is pressed by the input operation by the user, and content based on the designated path or file is input.

Subsequently, when a retrieval button (retrieve) is pressed by the input operation by the user, the above-described content reading processing is executed.

In the third example, as illustrated in FIG. 7, an answer UI image G3 to present an answer is displayed. In an answer output area of the answer UI image G3, for example, an answer acquired by the content reading processing based on the question query and the content input to the retrieval UI image G2 illustrated in FIG. 6 is presented. In the example of FIG. 7, in the answer output area of the answer UI image G3, a plurality of answers (answer candidates) is arranged and presented from the top in descending order of the certainty factors (score). Note that although an answer having the highest certainty factor is treated as an answer that is the most suitable for the question query, both the answers and the certainty factors thereof may be provided to the user as illustrated in the example of FIG. 7. Furthermore, in a question input area of the answer UI image G3, the question query input to the retrieval UI image G2 illustrated in FIG. 6 is presented. In the example of FIG. 7, a sentence “What is the launch date of BB4?” is presented.

In the fourth example, as illustrated in FIG. 8, an answer UI image G4 to present an answer is displayed. In an answer output area of the answer UI image G4, one answer is presented, and basis information W2 that is a basis of the answer is presented. In the example of FIG. 8, “CCEE” is presented as the answer, and an “image of CCDD” and a “profile of CCEE” of a daughter of CCDD are presented as the basis information W2. In addition, a question query is presented in the question input area of the answer UI image G4. In the example of FIG. 8, a sentence “Who is the daughter of CCDD?” is presented. Note that as the basis information W2, for example, various kinds of information such as knowledge graph information may be used.

In the fifth example, as illustrated in FIG. 9, the retrieval UI image G2 (see FIG. 6) and a selection UI image G5 to select new content are displayed. In a selection output area of the selection UI image G5, pieces of new content are arranged and presented from the top in descending order of certainty factors (score). In the example of FIG. 9, one piece of the new content is selected from the pieces of new content according to input operation on the input unit 12 by the user. In addition, a question query is presented in the question input area of the retrieval UI image G2. In the example of FIG. 9, a sentence “What is the launch date of BB4?” is presented.

The UI images G1 to G5 as described above are generated by the providing unit 156, transmitted to the display unit 13, and displayed by the display unit 13. As a result, since the user can visually recognize answer information regarding an answer, a certainty factor, and the like, the user can easily grasp various kinds of information related to the answer information. For example, the user can grasp a certainty factor of an answer in addition to the answer in the third example, and the user can grasp a basis of an answer in addition to the answer in the fourth example. Thus, the convenience of the user can be improved. In addition, since the user can perform the input operation on each of the UI images G1 to G5 and the input operation can be facilitated, the convenience of the user can be improved.

<2-5. Effects According to the Embodiment>

The information processing device 100 according to the embodiment includes the reception unit 154 that receives answer information related to a first answer that corresponds to a question query indicating a question about first content and that is generated on the basis of the first content, and the generation unit 153 that generates a second answer corresponding to the question query on the basis of second content (new content) different from the first content in a case where the answer information does not satisfy a predetermined condition. As a result, in a case where the answer information based on the first content does not satisfy the predetermined condition, for example, in a case where the first answer cannot be acquired from the first content, the second answer to the question query is generated on the basis of the second content. Thus, it is possible to reliably acquire the answer to the question query and to increase a correct answer probability.

In addition, in a case where the answer information indicates that the first answer cannot be acquired, the generation unit 153 generates the second answer on the basis of the second content. As a result, in a case where the first answer cannot be acquired, the second answer to the question query is generated on the basis of the second content, whereby the answer to the question query can be reliably acquired.

In addition, the reception unit 154 receives the first answer and a certainty factor of the first answer as the answer information, and the generation unit 153 generates the second answer on the basis of the second content in a case where the certainty factor of the first answer is smaller than a predetermined threshold. As a result, in a case where the first answer is inaccurate, the second answer to the question query is generated on the basis of the second content, whereby an accurate answer to the question query can be reliably acquired.

Furthermore, the information processing device 100 includes the content retrieval unit 155 that selects the second content on the basis of the question query. The generation unit 153 generates the second answer on the basis of the selected second content. As a result, since the second content related to the question query is selected and used for generation of the second answer, the answer to the question query can be acquired more reliably.

Furthermore, the content retrieval unit 155 selects the second content on the basis of the first content in addition to the question query. As a result, since the second content related to the question query and the first content is selected and used for generation of the second answer, the answer to the question query can be acquired more reliably.

Furthermore, the information processing device 100 includes the providing unit 156 that provides the second answer. As a result, a device in a provision destination can perform various kinds of processing by using the second answer. For example, in a case where the device in the provision destination is the display unit 13, the display unit 13 can display the second answer. Thus, the user can grasp the second answer. Note that the device in the provision destination may be a sound output unit that outputs the second answer by sound, a printing unit that prints and outputs the second answer, or the like, and is not specifically limited (the same applies to the device in the provision destination in the following).

Furthermore, the providing unit 156 provides the second answer and a position indicating the second answer in the second content. As a result, a device in the provision destination can perform various kinds of processing by using the second answer and the position of the second answer. For example, in a case where the device in the provision destination is the display unit 13, the display unit 13 can display the second answer together with the position indicating the second answer in the second content, whereby the user can grasp the position indicating the second answer in the second content together with the second answer.

Furthermore, the providing unit 156 provides the second answer and a certainty factor of the second answer. As a result, the device in the provision destination can perform various kinds of processing by using the second answer and the certainty factor of the second answer. For example, in a case where the device in the provision destination is the display unit 13, the display unit 13 can display the second answer together with the certainty factor of the second answer, whereby the user can grasp the certainty factor of the second answer together with the second answer.

Furthermore, in a case where there is a plurality of the second answers, the providing unit 156 provides the plurality of second answers side by side in order of certainty factors of the second answers. For example, in a case where the device in the provision destination is the display unit 13, the display unit 13 can display the second answers side by side in order of the certainty factors of the second answers, whereby the user can grasp the certainty factors of the second answers together with the second answers.

In addition, the generation unit 153 acquires a basis for the second answer from the second content, and the providing unit 156 provides the second answer and the basis for the second answer. As a result, the device in the provision destination can perform various kinds of processing by using the second answer and the basis of the second answer. For example, in a case where the device in the provision destination is the display unit 13, the display unit 13 can display the second answer together with the basis of the second answer, whereby the user can grasp the basis of the second answer together with the second answer.

Furthermore, the information processing device 100 includes the providing unit 156 that provides the UI images G1 to G5 to designate the second content. As a result, the device in the provision destination can perform various kinds of processing by using the UI images G1 to G5. For example, in a case where the device in the provision destination is the display unit 13, the display unit 13 can display the UI images G1 to G5, whereby the user can grasp the UI images G1 to G5 and perform operation and the convenience of the user can be improved.

Furthermore, in a case where there is a plurality of pieces of the second content, the providing unit 156 provides the plurality of pieces of second content side by side in order of the certainty factors of the pieces of the second content. For example, in a case where the device in the provision destination is the display unit 13, the display unit 13 can display the pieces of second content side by side in order of the certainty factors of the pieces of second content, whereby the user can grasp the certainty factors of the pieces of second content together with the pieces of second content.

In addition, the second content is content having a larger information amount than the first content. As a result, since the second answer is generated on the basis of the second content having the larger information amount than the first content, the answer to the question query can be acquired more reliably. For example, in the new content retrieval, an information amount of content (first content) input by the user is calculated, and new content (second content) having an information amount larger than the information amount is retrieved from a database.

Furthermore, the second content is content having lower confidentiality than the first content (such as content for internal use only). As a result, since the second content can be acquired from a network area wider than a network area in which the first content is acquired, the second content can be reliably acquired and the answer to the question query can be more reliably acquired.

In addition, the first content is content acquired from the first communication network (such as LAN or in-house network) N1, and the second content is content acquired from the second communication network (such as the Internet or external network) N2 having lower confidentiality than the first communication network N1. As a result, since the second content can be acquired from the second communication network N2 that is as a network area wider than the first communication network N1 that is as a network area in which the first content is acquired, the second content can be reliably acquired and the answer to the question query can be more reliably acquired.

In addition, the first content is a document, a moving image, voice, a song, or an image, and the second content is a document, a moving image, voice, a song, or an image. As a result, for example, a combination of various kinds of content can be used as the first content and the second content according to a field (such as industry type, industry field, or the like) related to the question query, and the answer to the question query can be more reliably acquired.

In addition, a type of the first content and a type of the second content are different from each other. Accordingly, as the first content and the second content, for example, a combination of a plurality of pieces of content of different types can be used according to a field related to the question query. In a certain field, for example, there may be more pieces of content in the type of the second content than in the type of the first content. In such a case, the second content can be reliably acquired, and the answer to the question query can be more reliably acquired

In addition, the first content is a document, and the second content is a moving image, voice, a song, or an image. Accordingly, as the first content and the second content, for example, a combination of a plurality of pieces of content of different types can be used according to a field related to the question query. In a certain field, for example, there may be more pieces of content in the moving image, voice, song, or image of the second content than in the document of the first content. In such a case, the second content can be reliably acquired, and the answer to the question query can be more reliably acquired

### 3. Other Embodiments

The processing according to each of the above-described embodiments may be performed in various different forms (modification examples) other than each of the above-described embodiments. For example, a system configuration is not limited to the above-described example, and may be in various modes. This point will be described below. Note that a description of points similar to those of the information processing device 100 according to the embodiment will be arbitrarily omitted in the following.

<3-1. Modification Example>

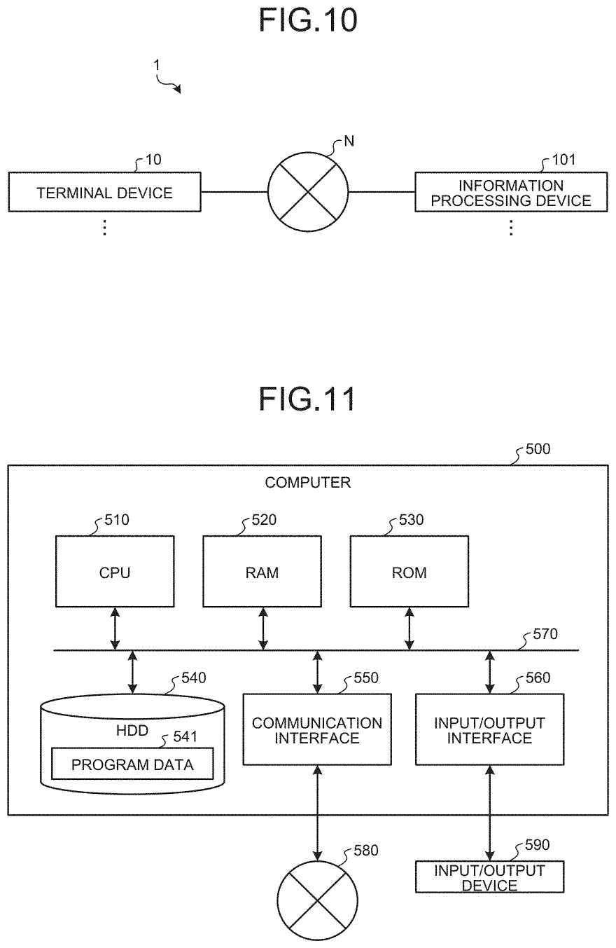

In the above-described example, for example, an example in which the information processing device 100 that is the terminal device used by the user performs the content reading processing has been described. However, an information processing device that performs the content reading processing and a terminal device used by the user may be separate bodies. This modification example will be described with reference to FIG. 10. FIG. 10 is a view illustrating a configuration example of an information processing system according to the modification example.

As illustrated in FIG. 10, an information processing system 1 includes a terminal device 10 and an information processing device 101. The terminal device 10 and the information processing device 101 are communicably connected in a wired or wireless manner via a communication network N (such as first communication network N1, second communication network N2, or the like). Note that the information processing system 1 may include a plurality of the terminal devices 10 and a plurality of the information processing devices 101. The information processing device 101 communicates with the terminal device 10 via the communication network N, and executes the above-described content reading processing on a question query, content, or the like provided from the terminal device 10.

The terminal device 10 is an information processing device used by the user. This terminal device 10 is a client terminal. The terminal device 10 is realized by, for example, a notebook personal computer (PC), a desktop PC, a smartphone, a tablet terminal, a cellular phone, a personal digital assistant (PDA), or the like. Note that the terminal device 10 may be any terminal device as long as the information provided by the information processing device 101 can be displayed.

Also, the terminal device 10 receives input operation by the user. This terminal device 10 receives various kinds of information from the information processing device 101 and displays the received various kinds of information on a screen. For example, the terminal device 10 receives answer information provided by the information processing device 101 and information such as various UI images G1 to G5, and performs a display thereof on a screen of a display. Furthermore, the terminal device 10 transmits information such as the question query and content to the information processing device 101.

The information processing device 101 realizes information processing similar to that of the information processing device 100 (content reading processing) except that the information processing device 101 is different from the information processing device 100 in a point of providing information to the terminal device 10 and acquiring information from the terminal device 10. This information processing device 101 is a server that provides service to the terminal device 10 that is the client terminal. For example, the information processing device 101 executes the content reading processing and the like on the basis of the information such as the question query and content provided from the terminal device 10, and transmits a result of the execution (such as answer information) to the terminal device 10. Furthermore, the information processing device 101 transmits the various UI images G1 to G5 to the terminal device 10 as necessary.

<3-2. Other Modification Examples>

Note that the processing according to each of the above-described embodiments and the modification example may be performed in various different forms (modification examples) other than the above-described embodiments and modification example. For example, among the pieces of processing described in the above embodiments, a whole or part of the processing described to be automatically performed can be manually performed, or a whole or part of the processing described to be manually performed can be automatically performed by a known method. In addition, the processing procedures, specific names, and information including various kinds of data or parameters illustrated in the above document or in the drawings can be arbitrarily changed unless otherwise specified. For example, various kinds of information illustrated in each drawing are not limited to the illustrated information.

Also, each component of each of the illustrated devices is a functional concept, and does not need to be physically configured in the illustrated manner. That is, a specific form of distribution/integration of each device is not limited to what is illustrated in the drawings, and a whole or part thereof can be functionally or physically distributed/integrated in an arbitrary unit according to various loads and usage conditions.

Also, the above-described embodiments and modification examples can be arbitrarily combined in a range in which the processing contents do not contradict each other. Also, the effect described in the present description is merely an example and is not a limitation, and there may be another effect.

<3-3. Hardware Configuration>

A specific hardware configuration of information equipment such as the information processing device 100 or 101 according to each of the above-described embodiments will be described. The information equipment such as the information processing device 100 or 101 according to each of the above-described embodiments is realized by, for example, a computer 500 having a configuration in a manner illustrated in FIG. 11. FIG. 11 is a view illustrating a configuration example of hardware that realizes functions of the information equipment such as the information processing device 100 or 101 according to each of the embodiments.

The computer 500 includes a CPU 510, a RAM 520, a read only memory (ROM) 530, a hard disk drive (HDD) 540, a communication interface 550, and an input/output interface 560. Each unit of the computer 500 is connected by a bus 570.

The CPU 510 operates on the basis of programs stored in the ROM 530 or the HDD 540, and controls each unit. For example, the CPU 510 develops the programs stored in the ROM 530 or the HDD 540 into the RAM 520, and executes processing corresponding to the various programs.

The ROM 530 stores a boot program such as a basic input output system (BIOS) executed by the CPU 510 when the computer 500 is activated, a program depending on hardware of the computer 500, and the like.

The HDD 540 is a computer-readable recording medium that non-temporarily records a program executed by the CPU 510, data used by the program, and the like. Specifically, the HDD 540 is a recording medium that records an information processing program according to the present disclosure which program is an example of program data 541.

The communication interface 550 is an interface with which the computer 500 is connected to an external network 580 (such as the Internet). For example, the CPU 510 receives data from other equipment or transmits data generated by the CPU 510 to other equipment via the communication interface 550.

The input/output interface 560 is an interface to connect an input/output device 590 and the computer 500. For example, the CPU 510 receives data from an input device such as a keyboard or mouse via the input/output interface 560. Furthermore, the CPU 510 transmits data to an output device such as a display, speaker, or printer via the input/output interface 560.

Note that the input/output interface 560 may function as a medium interface that reads a program or the like recorded on a predetermined recording medium (medium). As the medium, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like is used.

Here, for example, in a case where the computer 500 functions as the information processing device 100 according to the embodiment, the CPU 510 of the computer 500 realizes a function of the control unit 15 or the like by executing the information processing program loaded on the RAM 520. Also, the HDD 540 stores the information processing program according to the present disclosure, and data in the storage unit 14. Note that the CPU 510 reads the program data 541 from the HDD 540 and performs execution thereof, but may acquire these programs from another device via the external network 580 in another example.

### 4. Appendix

Note that the present technology can also have the following configurations.

(1)

An information processing device comprising:
a reception unit that receives answer information related to a first answer that corresponds to a question query indicating a question about first content and that is generated on a basis of the first content; and
a generation unit that generates a second answer corresponding to the question query on a basis of second content different from the first content in a case where the answer information does not satisfy a predetermined condition.

(2)

The information processing device according to (1), wherein
the generation unit
generates the second answer on a basis of the second content in a case where the answer information indicates that the first answer cannot be acquired.

(3)

The information processing device according to (1) or (2), wherein
the reception unit
receives the first answer and a certainty factor of the first answer as the answer information, and
the generation unit
generates the second answer on a basis of the second content in a case where the certainty factor is smaller than a predetermined threshold.

(4)

The information processing device according to any of (1) to (3), further comprising
a content retrieval unit that selects the second content on a basis of the question query, wherein
the generation unit generates the second answer on a basis of the selected second content.

(5)

The information processing device according to (4), wherein
the content retrieval unit
selects the second content on a basis of the first content in addition to the question query.

(6)

The information processing device according to any of (1) to (5), further comprising
a providing unit that provides the second answer.

(7)

The information processing device according to (6), wherein
the providing unit
provides the second answer and a position indicating the second answer in the second content.

(8)

The information processing device according to (6) or (7), wherein
the providing unit
provides the second answer and a certainty factor of the second answer.

(9)

The information processing device according to (8), wherein
the providing unit
provides, in a case where there is a plurality of the second answers, the plurality of second answers side by side in order of certainty factors of the second answers.

(10)

The information processing device according to any of (6) to (9), wherein
the generation unit
acquires a basis of the second answer from the second content, and
the providing unit
provides the second answer and the basis for the second answer.

(11)

The information processing device according to any of (1) to (5), further comprising
a providing unit that provides a user interface image to designate the second content.

(12)

The information processing device according to (11), wherein
the providing unit
provides, in a case where there is a plurality of pieces of the second content, the plurality of pieces of second content side by side in order of certainty factors of the pieces of second content.

(13)

The information processing device according to any of (1) to (12), wherein
the second content is content having a larger information amount than the first content.

(14)

The information processing device according to any of (1) to (13), wherein
the second content is content having lower confidentiality than the first content.

(15)

The information processing device according to any of (1) to (14), wherein
the first content is content acquired from a first communication network, and
the second content is content acquired from a second communication network having lower confidentiality than the first communication network.

(16)

The information processing device according to any of (1) to (15), wherein
the first content is a document, a moving image, voice, a song, or an image, and
the second content is a document, a moving image, voice, a song, or an image.

(17)

The information processing device according to any of (1) to (15), wherein
a type of the first content and a type of the second content are different from each other.

(18)

The information processing device according to (17), wherein
the first content is a document, and
the second content is a moving image, voice, a song, or an image.

(19)

An information processing method comprising:
receiving answer information related to a first answer that corresponds to a question query indicating a question about first content and that is generated on a basis of the first content; and
generating a second answer corresponding to the question query on a basis of second content different from the first content in a case where the answer information does not satisfy a predetermined condition.

### REFERENCE SIGNS LIST

11 COMMUNICATION UNIT
12 INPUT UNIT
13 DISPLAY UNIT
14 STORAGE UNIT
15 CONTROL UNIT
100 INFORMATION PROCESSING DEVICE
101 INFORMATION PROCESSING DEVICE
151 EMBEDDING UNIT
152 ANSWER RETRIEVAL UNIT
153 GENERATION UNIT
154 RECEPTION UNIT
155 CONTENT RETRIEVAL UNIT
156 PROVIDING UNIT
G5 SELECTION UI IMAGE

1. An information processing device comprising:
a reception unit that receives answer information related to a first answer that corresponds to a question query indicating a question about first content and that is generated on a basis of the first content; and
a generation unit that generates a second answer corresponding to the question query on a basis of second content different from the first content in a case where the answer information does not satisfy a predetermined condition.

2. The information processing device according to claim 1, wherein
the generation unit
generates the second answer on a basis of the second content in a case where the answer information indicates that the first answer cannot be acquired.

3. The information processing device according to claim 1, wherein
the reception unit
receives the first answer and a certainty factor of the first answer as the answer information, and
the generation unit
generates the second answer on a basis of the second content in a case where the certainty factor is smaller than a predetermined threshold.

4. The information processing device according to claim 1, further comprising
a content retrieval unit that selects the second content on a basis of the question query, wherein
the generation unit generates the second answer on a basis of the selected second content.

5. The information processing device according to claim 4, wherein
the content retrieval unit
selects the second content on a basis of the first content in addition to the question query.

6. The information processing device according to claim 1, further comprising
a providing unit that provides the second answer.

7. The information processing device according to claim 6, wherein
the providing unit
provides the second answer and a position indicating the second answer in the second content.

8. The information processing device according to claim 6, wherein
the providing unit
provides the second answer and a certainty factor of the second answer.

9. The information processing device according to claim 8, wherein
the providing unit
provides, in a case where there is a plurality of the second answers, the plurality of second answers side by side in order of certainty factors of the second answers.

10. The information processing device according to claim 6, wherein
the generation unit
acquires a basis of the second answer from the second content, and
the providing unit
provides the second answer and the basis for the second answer.

11. The information processing device according to claim 1, further comprising
a providing unit that provides a user interface image to designate the second content.

12. The information processing device according to claim 11, wherein
the providing unit
provides, in a case where there is a plurality of pieces of the second content, the plurality of pieces of second content side by side in order of certainty factors of the pieces of second content.

13. The information processing device according to claim 1, wherein
the second content is content having a larger information amount than the first content.

14. The information processing device according to claim 1, wherein
the second content is content having lower confidentiality than the first content.

15. The information processing device according to claim 1, wherein
the first content is content acquired from a first communication network, and
the second content is content acquired from a second communication network having lower confidentiality than the first communication network.

16. The information processing device according to claim 1, wherein
the first content is a document, a moving image, voice, a song, or an image, and
the second content is a document, a moving image, voice, a song, or an image.

17. The information processing device according to claim 1, wherein
a type of the first content and a type of the second content are different from each other.

18. The information processing device according to claim 17, wherein
the first content is a document, and
the second content is a moving image, voice, a song, or an image.

19. An information processing method comprising:
receiving answer information related to a first answer that corresponds to a question query indicating a question about first content and that is generated on a basis of the first content; and
generating a second answer corresponding to the question query on a basis of second content different from the first content in a case where the answer information does not satisfy a predetermined condition.
